(19) United States
(12) Patent Application Publication
(10) Pub. No.: US 2014/0326400 A1
(43) Pub. Date: Nov. 6, 2014

(54) ROBUST MONOLITHIC MICROMECHANICAL VALVES FOR HIGH DENSITY MICROFLUIDIC VERY LARGE SCALE INTEGRATION

(71) Applicants: Ismail Emre Araci, Redwood City, CA (US); Stephen Quake, Aptos, CA (US); Michael Robles, Aptos, CA (US); Daniel Bechstein, Palo Alto, CA (US)

(72) Inventors: Ismail Emre Araci, Redwood City, CA (US); Stephen Quake, Aptos, CA (US); Michael Robles, Aptos, CA (US); Daniel Bechstein, Palo Alto, CA (US)

(21) Appl. No.: 14/266,381

(22) Filed: Apr. 30, 2014

Related U.S. Application Data
(60) Provisional application No. 61/818,406, filed on May 1, 2013.

(51) Int. Cl. F16K 99/00; B32B 37/24

(52) U.S. Cl. CPC F16K 99/0001; B32B 37/24
USPC 156/242

(57) ABSTRACT

A fabrication method of a micromechanical valve includes: (1) forming a control layer according to a first weight ratio of cross linker: elastomer base; (2) forming a flow layer according to a second weight ratio of cross linker: elastomer base; (3) forming a membrane layer according to a third weight ratio of cross linker: elastomer base, where the third weight ratio is smaller than the first weight ratio, and is smaller than the second weight ratio; (4) bonding the membrane layer to the control layer to form a two-layer structure; and (5) bonding the two-layer structure to the flow layer to form the micromechanical valve.

### CROSS REFERENCE TO RELATED APPLICATION

This application claims the benefit of U.S. Provisional Application Ser. No. 61/818,406, filed on May 1, 2013, the disclosure of which is incorporated herein by reference in its entirety.

### FIELD OF THE INVENTION

The invention generally relates to micromechanical valves and, more particularly, high density (e.g., one million per one cm² of chip area) and robust monolithic micromechanical valves for microfluidic very large scale integration (mVLSI) technology.

### BACKGROUND

Microfluidics is the technology of systems that manipulate small amounts of fluids, typically on the nanoliter scale and below. Numerous applications of microfluidics have been developed for various fields such as chemistry and biology. Additionally, many technological innovations have been developed to control fluid behavior for these applications. Amongst these, monolithic micromechanical valves have been attractive due to ease of fabrication, low cost, and scalability. The development of microfluidic chips with hundreds to thousands of integrated micromechanical valves is referred as microfluidic large scale integration (mLSI). mLSI allows hundreds to thousands of assays to be performed in parallel, using multiple reagents in an automated manner, and has been used in applications such as protein crystallography, genetic analysis, high-throughput screening, and chemical synthesis.

There are two basic aspects for mLSI technology: monolithic microvalves that are leakproof and scalable, and a method of multiplexed addressing and control of these valves. Typical valve dimension in mLSI studies reported so far are 100 μm or higher. Reducing the valve dimensions by an order of magnitude will allow chips with two orders of magnitude higher density. In order to solve the macroscopic-microfluidic interface problem for highly parallel analysis (>100 different experiments) on a single chip, control elements (e.g., valves) are desired. It is desirable to achieve one million control elements in a single chip for micromechanical valve dimensions below 10 μm×10 μm. This would allow automated control through utilizing techniques like on-chip multiplexing and on-chip reagent mixing, and provide high sensitivity and dynamic range, simultaneously.

It is against this background that a need arose to develop the micromechanical valves described herein.

### SUMMARY

Embodiments of this disclosure are directed to micromechanical valves and, more particularly, high density and robust monolithic micromechanical valves for mVLSI technology. In some embodiments, mVLSI technology attains a density of greater than about 1×10⁴ valves (or other control elements) per one cm² of chip area, such as at least about 3×10⁴ valves (or other control elements) per one cm² of chip area, at least about 5×10⁴ valves (or other control elements) per one cm² of chip area, at least about 7×10⁴ valves (or other control elements) per one cm² of chip area, at least about 1×10⁵ valves (or other control elements) per one cm² of chip area, at least about 3×10⁵ valves (or other control elements) per one cm² of chip area, at least about 5×10⁵ valves (or other control elements) per one cm² of chip area, at least about 7×10⁵ valves (or other control elements) per one cm² of chip area, or at least about 1×10⁶ valves (or other control elements) per one cm² of chip area, and up to about 1×10⁷ valves (or other control elements) per one cm² of chip area or more. One million valves per cm² density is about two orders of magnitude improvement over the state of the art. In addition, a three-layer architecture for micromechanical valves is superior to a two-layer valve architecture for fabrication of high density chips.

Embodiments of this disclosure address various challenges for microfluidics. One of them is increasing the number of control elements on a microfluidic chip, and a second one is miniaturization of microfluidic chips. A third one is mitigating against absorption and evaporation issues encountered with certain elastomers used in microfluidic chips, such as polydimethylsiloxane (PDMS). In some embodiments, these issues are addressed by applying a suitable coating in a flow layer, along with a bonding technique that can withstand high pressures, such as greater than about 50 pounds per square inch (psi) (or greater than about 345 kPa). A fourth one is mitigating against humidity and related degradation of chip performance, by maintaining relatively low levels of humidity during curing to reduce a surface roughness of microfluidic chips, and to provide improved reproducibility in Young's modulus values for a membrane layer.

Applications of mVLSI technology include, for example, digital polymerase chain reaction, digital enzyme-linked immunosorbent assay, digital multiple displacement amplification, single cell genomic analysis, biosensors, optofluidics, and reducing the number of pipetting operations in various applications in chemistry and biology.

Some aspects of this disclosure relate to a fabrication method of a micromechanical valve. In some embodiments, the method includes: (1) forming a control layer according to a first weight ratio of cross linker: elastomer base; (2) forming a flow layer according to a second weight ratio of cross linker: elastomer base; (3) forming a membrane layer according to a third weight ratio of cross linker: elastomer base, where the third weight ratio is smaller than the first weight ratio, and is smaller than the second weight ratio; (4) bonding the membrane layer to the control layer to form a two-layer structure; and (5) bonding the two-layer structure to the flow layer to form the micromechanical valve.

In other embodiments, the method includes: (1) forming a first layer having a first elastic modulus; (2) forming a second layer having a second elastic modulus; (3) forming a membrane layer having a third elastic modulus, wherein the third elastic modulus is smaller than the first elastic modulus, and is smaller than the second elastic modulus; (4) bonding the membrane layer to the first layer to form a multi-layer structure; and (5) bonding the multi-layer structure to the second layer to form the micromechanical valve.

Other aspects of this disclosure relate to micromechanical valves formed according to the disclosed methods, microfluidic chips including arrays of micromechanical valves, and methods of operating micromechanical valves and microfluidic chips.

Additional aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1: (a)-(g) Fabrication operations and cross sections of a three-layer design for a micromechanical valve.

FIG. 2: Pressure to achieve about 3 μm deflection, w₀, with respect to membrane diameter, 2a, and Young's modulus, E, for membrane thickness t of about 0.3 μm. The line indicates the about 280 kPa pressure value that can be practically applied to microfluidic chips. See the inset for the schematics of the model geometry and description of the parameters.

FIG. 3: Open (top) and closed (middle) 8×8 and 6×6 μm² valves under differential pressure (P_{control}-P_{flow}) of about 280 kPa. Demonstration of the channel crossover (bottom); the flow channel on the left is closed while the one on the right remains open when the control channel width is reduced to about 4 μm or less.

FIG. 4: Valve sealing is demonstrated by observing the Brownian motion of the beads; Top: About 0.5 μm diameter fluorescent beads are flowing in the direction of the white arrow under about 35 kPa flow channel pressure; the fluorescence traces of flowing beads are visible. Middle: The up- and downstream valves of the flow channel are closed at about 200 kPa differential pressure while the flow channel is still pressurized. A captured bead is shown at t=0. After about 10 min of free motion, the same bead is shown on middle, right. The photobleaching of the bead fluorescence signal is observed due to constant excitation. Bottom: The track of the bead for about 5 min period with about 5 sec intervals is shown.

FIG. 5: Hysteresis curves showing the electrical resistance of a flow channel filled with MgCl₂ solution in water with respect to differential pressure applied to control channel. One curve is for about 100 μm flow channel width, and another curve is for about 8 μm flow channel width.

FIG. 6: Miniaturized valves that are closed after about 2 min (top) and held closed overnight (bottom).

FIG. 7: Actuation pressure for valves as a function of partial curing time for a membrane layer.

FIG. 8a: Actuation pressure for valves as a function of polydimethylsiloxane mixing ratio with a cross linker.

FIG. 8b: Actuation pressure for valves as a function of membrane size.

FIG. 9: Actuation pressure for valves as a function of curing time for a control layer.

FIG. 10: Operation of valves, with the valves open (left), and the valves closed (right).

FIG. 11: Chip design for single enzyme detection.

FIG. 12: Enzyme and substrate are filled into two different channels, and subsequent mixed in each chamber.

FIG. 13: Demonstration of digital counting in an mVLSI chip.

FIG. 14: Demonstration of digital behavior.

FIG. 15: Resorufin absorption after about 2 hours on polydimethylsiloxane without a Parylene coating (left) and with a Parylene coating (right).

### DETAILED DESCRIPTION

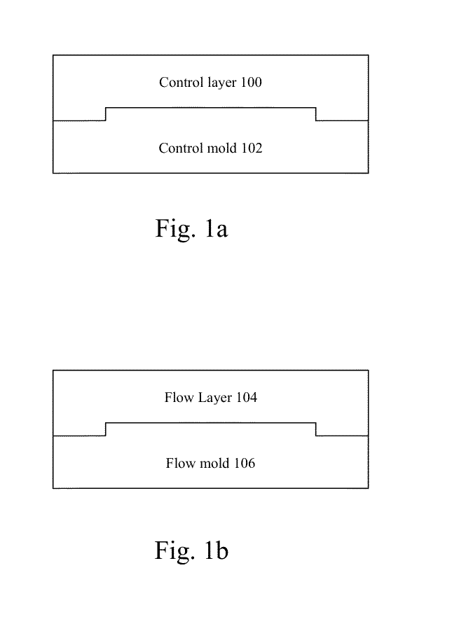

FIG. 1 shows a fabrication method of robust mVLSI chips with practical actuation pressures, according to an embodiment of this disclosure. The fabrication method allows the formation of mVLSI chips with valve dimensions of about 10×10×10 μm³ or smaller.

In the embodiment of FIG. 1, polydimethylsiloxane (PDMS) is used as an elastomer to form various layers of a micromechanical valve. Another silicone or other types of elastomers or polymers can be used in place of, or in combination with, PDMS, such as polyisoprene, polybutadiene, polychloroprene, polyisobutylene, polystyrene-butadiene-styrene), and polyurethanes. It is also contemplated that various layers of the micromechanical valve can be formed of different elastomers.

First, referring to FIG. 1a and FIG. 1b, two parts of PDMS are mixed with a weight ratio of cross linker (e.g., methyltrichlorosilane or other suitable cross linking agent) to elastomer base (e.g., PDMS oligomers and polymers or precursors of such oligomers and polymers) (cross linker:elastomer base) of at least about 1:15, such as at least about 1:10, at least about 2:15, at least about 3:20, or at least about 1:5, and up to about 1:4, up to about 3:10, or more. The mixtures are spin coated (or otherwise applied) slowly on control and flow molds 102 and 106 to form two relatively thick layers 100 and 104 for control and flow channels. In order to reduce an actuation pressure, a cross linker weight ratio can be selected to yield a high elastic modulus for the control layer 100, such as in the range of about 1:15 to about 1:4 or about 1:10. For example, a cross linker weight ratio of about 1:10 for the control layer 100 can yield a lowest actuation pressure in some embodiments. The control layer 100 and the flow layer 104 are then at least partially cured in a curing oven. In some embodiments, curing either, or both, the control layer 100 and the flow layer 104 can be carried out under conditions of relatively low humidity to reduce a surface roughness and promote bonding of various layers. For example, a Relative Humidity (RH) during curing can be maintained at about 40% or below, about 30% or below, about 20% or below, about 10% or below, or about 5% or below, and can be attained by flowing or pumping dry air into the curing oven, where the dry air has a RH of about 40% or below, about 30% or below, about 20% or below, about 10% or below, or about 5% or below. Curing time for the control layer 100 can be in the range of about 10 min to about 70 min, such as from about 20 min to about 60 min or from about 30 min to about 60 min. Cross linker weight ratios for the control layer 100 and the flow layer 104 can be the same or different.

In addition to the control and flow layers 100 and 104, a membrane layer 108 is formed by mixing two parts of PDMS with a weight ratio of cross linker to elastomer base (cross linker:elastomer base) no greater than about 1:20, such as no greater than about 1:25 or no greater than about 1:30, and down to about 1:35, down to about 1:40, or less. As shown in FIG. 1c, the mixture is spin coated (or otherwise applied) on a blank silicon wafer 110 (or another suitable substrate) with no greater than about 1 μm thickness, such as up to about 0.99 μm thickness, up to about 0.9 μm thickness, up to about 0.8 μm thickness, up to about 0.7 μm thickness, up to about 0.6 μm thickness, up to about 0.5 μm thickness, up to about 0.4 μm thickness, or up to about 0.3 μm thickness, and down to about 0.2 μm thickness, down to about 0.1 μm thickness, or less. The thickness of the membrane layer 108 can be substantially uniform, such as exhibiting a standard deviation no greater than about 30% of an average thickness, no greater than about 20% of the average thickness, no greater than about 10% of the average thickness, or no greater than about 5% of the average thickness. The membrane layer 108 is partially cured in a curing oven. In some embodiments, curing of the membrane layer 108 can be carried out under conditions of relatively low humidity to reduce a surface roughness and promote bonding of various layers. Humidity control also can provide improved reproducibility in Young's modulus values for the membrane layer 108. For example, a RH during curing can be maintained at about 40% or below, about 30% or below, about 20% or below, about 10% or below, or about 5% or below, and can be attained by flowing or pumping dry air into the curing oven, where the dry air has a RH of about 40% or below, about 30% or below, about 20% or below, about 10% or below, or about 5% or below. As the partial curing time is reduced, the actuation pressure is also reduced. Curing time of the membrane layer 108 can be in the range of about 10 min to about 70 min, such as from about 20 min to about 60 min or from about 30 min to about 60 min.

Next, as shown in FIG. 1d, the membrane layer 108 is thermally bonded to the control layer 100 for at least about 5 min. The total time of curing in FIG. 1c and FIG. 1d should be short enough to leave the membrane layer 108 at least partially cured but should be long enough to ensure a collapse-free control channel 112.

Next, as shown in FIG. 1e, this two-layer structure is peeled off and perforated for control channel access openings 116 (inlets and outlets), and then thermally bonded to the flow layer 104 and cured in an oven until the membrane layer 108 is substantially fully cured.

Still referring to FIG. 1e, flow channel access openings 114 (inlets and outlets) are formed by punching, for example, and the three-layer structure is then plasma bonded to a glass substrate 120 and heated for about 10 min. The punching of the flow channel inlets and outlets 114 towards the end of the fabrication method is desirable to obtain clog-free operation.

The three-layer structure is then characterized for leakproof operation and robustness. In order to mitigate against diffusion through the membrane layer 108, the control channel 112 can be filled with liquids other than water, such as water immiscible liquids.

As shown in FIG. 1f and FIG. 1g, surfaces bounding the flow channel 118 can be coated with a layer of Parylene C 122 or another barrier layer to reduce the permeability of PDMS and mitigate against small molecule absorption and evaporation through walls of the flow layer 104. As shown in FIG. 1g, various surfaces of the flow layer 104 bounding the flow channel 118, including surfaces of side walls, can be coated with Parylene C. Parylene C refers to a member of a class of polyxylylene-based polymers, such as poly(p-xylylene) and its derivatives, and also include, for example, Parylene N, Parylene D, and Parylene F. To mitigate against delamination at or near the flow channel inlets and outlets 114, the Parylene C layer 122 can be selectively applied or deposited at or near a valve region of the flow layer 104 and away from the flow channel inlets and outlets 114. A shadow mask 124 can be selectively applied or deposited in regions of the flow layer 104 at or near the flow channel inlets and outlets 114 to confine the deposition of the Parylene C layer 122 to the valve region. Bonding of the control layer 100 and the membrane layer 108 to the flow layer 104 can be promoted by silanizing (e.g., with (3-Aminopropyl)triethoxysilane (APTES) or another aminosilane bonding agent) the flow layer 104 prior to bonding to increase the bonding strength. Silanization can be selectively performed at or near the valve region of the flow layer 104, namely at or near the Parylene C layer 122.

Referring to FIG. 1e and FIG. 1f, the resulting micromechanical valve can operate (e.g., close) based on an actuation pressure in the range of about 10 kPa to about 280 kPa, such as from about 20 kPa to about 250 kPa, from about 30 kPa to about 200 kPa, from about 30 kPa to about 150 kPa, from about 30 kPa to about 110 kPa, or from about 30 kPa to about 100 kPa. For example, 8×8, 6×6, 4×4 μm² valve sizes can be operated at about 42, about 80, and about 200 kPa differential pressure, respectively. An elastic modulus of the membrane layer 108 can be up to about 600 kPa, such as up to about 500 kPa, up to about 400 kPa, up to about 300 kPa, up to about 250 kPa, or up to about 200 kPa, and down to about 150 kPa, down to about 100 kPa, or less. An elastic modulus of each of the control layer 100 and the flow layer 104 can be greater than the elastic modulus of the membrane layer 108, such as at least about 1.1 times greater, at least about 1.3 times greater, at least about 1.5 times greater, at least about 1.7 times greater, at least about 2 times greater, at least about 2.5 times greater, at least about 3 times greater, or more. The elastic modulus of the control layer 100 and the elastic modulus of the flow layer 104 can be the same or different, and, in some embodiments, the elastic modulus of the control layer 100 can be greater than the elastic modulus of the flow layer 104. A lateral dimension (e.g., a largest lateral dimension) of the micromechanical valve can be up to about 50 μm, such as up to about 40 μm, up to about 30 μm, up to about 20 μm, up to about 15 μm, up to about 10 μm, up to about 8 μm, or up to about 6 μm, and down to about 4 μm, down to about 2 μm, or less.

### EXAMPLES

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

Microfluidic chips with a high density of control elements are desired to improve device performance parameters, such as throughput, sensitivity, and dynamic range. In order to realize robust and accessible high-density microfluidic chips, this example demonstrates the fabrication of a monolithic polydimethylsiloxane (PDMS) valve architecture with three layers, replacing a two-layer design. The design is realized through multilayer soft lithography techniques, making it low cost and easy to fabricate. By carefully determining the process conditions of PDMS, this example demonstrates that 8×8 and 6×6 μm² valve sizes can be operated at about 180 and about 280 kPa differential pressure, respectively. This example shows that these valves can be fabricated at densities approaching 1 million valves per cm², substantially exceeding the current state of the art of mLSI (thousands of valves per cm²). Because the density increase is greater than two orders of magnitude, this technology can be referred as microfluidic very large scale integration (mVLSI), analogous to its electronic counterpart. Fluorescent beads are captured and tracked, and the electrical resistance of a fluidic channel is changed by using these miniaturized valves in two different experiments, demonstrating that the valves are leakproof. This example also demonstrates that these valves can be addressed through multiplexing.

In this example, a three-layer chip design is developed in order to overcome reliability issues, which can be encountered in miniaturization of a two-layer chip architecture. There are two different valve types, both with two-layer cross-section; push-up and push-down. Push-up type valves can have lower actuation pressure compared to push-down valves due to flat geometry of the valve membrane. However, for both of these valve types, PDMS is spin coated on a mold that has photo-patterned resist features defining the chip design. Achieving a uniform membrane with a thickness much smaller than the resist thickness is difficult because of this spin coating process made directly on the mold. In the proposed design, a thin (<1 μm) PDMS film is sandwiched between flow and control layers, providing a flat and substantially uniform valve membrane similar to push-up valve geometry. The design allows a size reduction of more than an order of magnitude (100×100 μm² to 6×6 μm²) over other monolithic micromechanical valves. Chips made by this technique were reliably used over several days without any noticeable delamination or collapse. The results have demonstrated that these valves are leakproof, can be multiplexed, and also that they can be made in more than two orders of magnitude higher densities than mLSI (0.4M-0.8M valves/cm²). This mVLSI technology can open new possibilities for the field of optofluidics, since it pushes the scale of microfluidics one step closer to the scale of optical wavelengths.

Design and Fabrication

The thin valve membrane is obtained by spin coating PDMS on a blank silicon wafer at very high speeds and extended spin durations. This results in highly uniform films with a thickness as small as about 0.3 μm. In the experiments, it is observed that, as the PDMS cross linker mixing ratio reduced from about 1:10 to about 1:30, the resulting film thickness reduced from about 1 μm to about 0.3 μm for a spin speed of about 12,000 rpm, and spin duration of about 15 min. Due to its low viscosity and low Young's modulus (E), PDMS with low cross linker ratio (about 1:30) is used for the fabrication of valve membranes. In order to estimate the desired membrane thickness range, the analytical model for circular membranes is used. According to this model, a thin film with a diameter 2a and thickness t will involve pressure,

$$P = \frac{{C}_{1} t}{{a}^{2}} {σ}_{0} {w}_{0} + \frac{{C}_{2} f ( v ) t}{{a}^{4}} \frac{E}{1 - v} {w}_{0}^{3}$$

in order to achieve a maximum deflection, w₀, at the center of the membrane. Here v is the Poisson's ratio, σ₀ is the residual stress, C₁, C₂, and f(v) are parameters for circular membranes.

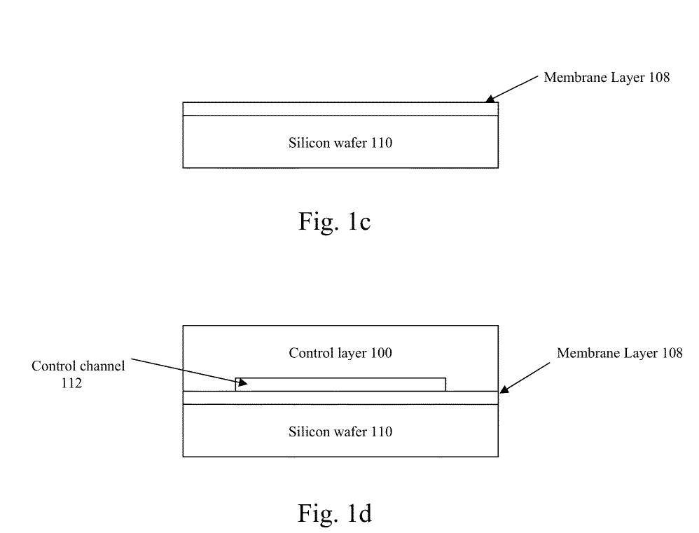

FIG. 2 shows the 3-dimensional surface plot of calculated pressure values to obtain about 3 μm deflection at the membrane center, with respect to membrane diameter and Young's modulus. The inset shows the model geometry and description of the parameters. The thickness of the film in this calculation is taken as about 0.3 μm. It is seen in the figure that, when membrane diameter is larger than about 6 μm, the pressure is well below about 280 kPa (a practical constraint, shown as a line in FIG. 2), for a large range of Young's modulus values. However for membranes with less than about 6 μm diameter the Young's modulus constraint is much stricter.

Equipped with this information, chips were fabricated with 4,096 valves with different sizes (about 5, about 6, and about 8 μm) at high density (about 0.4-1 million valves per cm²). The control and flow molds were first prepared by using lithography techniques. The channel height was selected as about 1.5 μm in order to ensure substantially complete sealing of the valves at about 3 μm maximum deflection. A 3″ silicon wafer is used as a substrate for the valve membrane. Then the mold surfaces are silanized with tetramethylchrolosilane vapor for at least about 2 h. PDMS (RTV615) mixture with a cross linker ratio of about 1:30 and volume of about 1 mL was dropped onto the substrate and spin coated for about 15 min at about 12,000 rpm with a Laurel! WS-650Mz-23NPP spin coater, and baked at about 80° C. for about 40 min. In the meantime, another PDMS (about 1:5) mixture was prepared for flow and control layers. PDMS was poured onto the control mold, degassed for about 30 min, and baked at about 80° C. for about 40 min. After this, PDMS for the control layer was cut, control channel access holes were punched, and this layer was placed onto the valve membrane layer. These two layers were baked at about 80° C. in an oven for about 1.5 h for thermal bonding. After thermal bonding, the sample was cooled down for about 10 min, and then both layers were peeled off and punched with access holes for flow channels. Flow layer was prepared as follows: PDMS was spin coated on the flow mold at about 500 rpm for about 1 min, which resulted in about 100 μm flow layer thickness. The flow layer was placed on a flat surface for about 10 min to let any air bubbles disappear. The flow layer was then baked at about 80° C. for about 2 h. At the end of the baking process, the PDMS was cut and placed on a thin coverslip so that the patterned side was facing upwards. The flow layer and the control/membrane layer were then bonded by plasma treatment technique; both layer surfaces were treated with O₂ plasma at about 70 Watt and about 0.2 mBar for about 30 s. A manual X-Y-Z-stage from Newport, a manual custom-made θ-stage, and an OPTEM 125C imaging system, equipped with a 10× long working distance objective and a CCD camera, were used for alignment. The flow layer was fixed on the θ-stage, and the control layer was placed on a thin glass coverslip to minimize optical aberrations, which was held by a vacuum chuck and subsequently placed on the X-Y-Z stage. The two layers were aligned within about 2 micron precision and brought into contact for bonding. Motorized stages can be used for even better precision. The chip was finally baked for about 10 min in order to ensure a stronger bond between control/membrane and flow layers. The chips were then tested.

Characterization

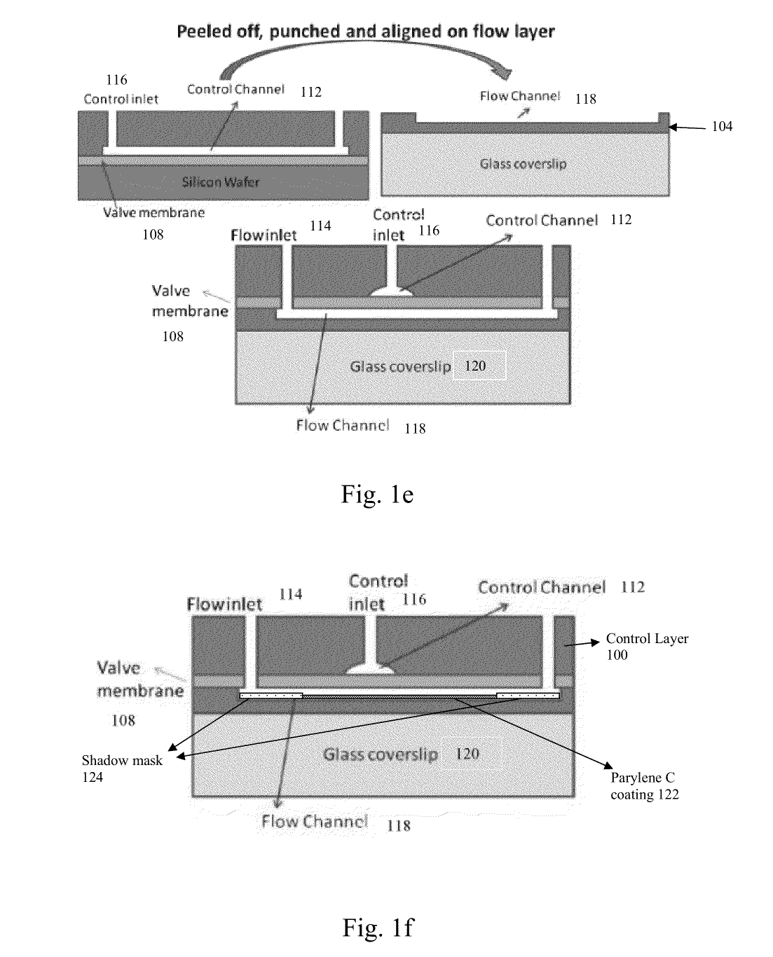

FIG. 3 shows the 8 and 6 μm valves before (open) and after (closed) actuation at about 280 kPa. Successful control was made of all valves simultaneously for the 6 and 8 μm valve size. Although some of the 5 μm valves were functional, the results were less consistent. The lateral shrinkage of the valves due to deformation of PDMS under the applied control line pressure was about 1 μm for both channel sizes. The 8 μm valves were operated at about 5 Hz. This value is about an order of magnitude lower than standard valves. The temporal response of miniaturized valves is mainly due to their slower closing times. In this example, the two factors that can contribute to the slower valve closing are: first, the applied force typically cannot be increased above about 0.02 nN (about 50 times lower than typical force in standard valves) because of the small valve dimensions and second, the high spring force (>200 kPa) of the valves.

For microfluidic multiplexing, it is desired to cross flow channels. When the control channel dimension is about 4 μm or less, it is possible to cross 6-8 μm wide flow channels without disturbing their flow, which demonstrates the multiplexing capability of miniaturized valves. The bottom image in FIG. 3 shows that 6×6 μm² valve on the left is closed, and 3×6 μm² valve on the right is open.

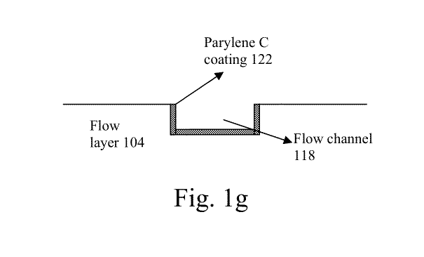

After showing that 6 and 8 μm valves are scalable and can be multiplexed, the results demonstrated that this valve architecture is leakproof by tracking the motion of about 0.5 μm diameter fluorescent beads in about 8 μm wide channels, which are controlled by the miniaturized valves. According to the one dimensional diffusion equation, average displacement-squared is given as:

<x²>=2Dt

where D [m² s⁻¹] is the diffusion constant, and t [sec] is the diffusion time. The diffusion constant for a bead with about 0.5 μm diameter in water is on the scale of about 10⁻¹² m²s⁻¹, which makes the expected displacement in about 10 min duration of about 100 μm. In order to demonstrate that the valves substantially completely seal the flow channels, about 35 kPa pressure was first applied to the flow channel, and movement of beads was observed as shown in FIG. 4 top image. It is seen that, when the beads are affected by the applied pressure, their fast drift motion results in a continuous fluorescence trace.

At t=0 both up and downstream valves were closed to trap beads in a single channel. One of these trapped beads is shown in FIG. 4, middle left. The motion of the bead is observed for about 10 min, and at the end the bead was still within the diffusion distance as shown in FIG. 4, middle right. The track of the bead making Brownian motion for about 5 min time period is shown in FIG. 4, bottom image. The darker dots show the start and end location of the bead, respectively. It is seen that the pressure difference in the flow channel does not cause a net drift in the direction of the flow, which demonstrates that the valves are leakproof. A single 0.1 μm diameter fluorescent bead also was trapped in a single 8×8 μm² chamber, and the bead movement was recorded for about 5 min.

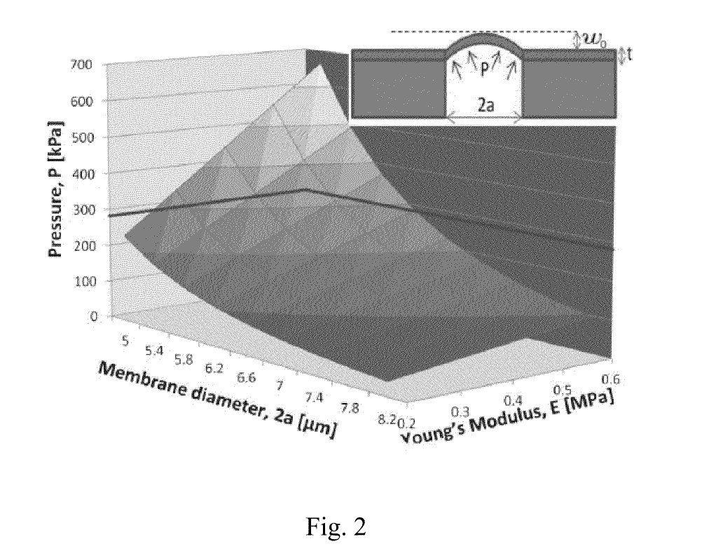

Finally, the valve behavior was characterized according to the following experimental protocol. The flow channels were filled with MgCl₂ solution in water for standard and miniaturized valve architectures with dimensions of about 100×100×8 and 8×8×1.5 μm³, respectively. The electrical resistance along the fluidic channels was measured continuously as the differential pressure (P_{control}-P_{flow}) was increased and then decreased. FIG. 5 shows the hysteresis curves obtained from the measurement. One line is for the miniaturized valves, and another line is for standard push-down geometry. The resistance difference of the two valve types for the open valve state is consistent with the difference in channel size and length. When the valves are closed, the resistance of standard valves increased to about 200 MΩ, and the resistance of miniaturized valves exceeded about 1 GΩ (maximum resistance which can be measured by the setup). The similar characteristic shapes of two different valve types can be interpreted as another indication for valve sealing. For 8 μm valves, the valve closure pressure is at about 190 kPa; however, after closing the valves, they remain sealed even when the pressure is reduced down to about 150 kPa.

Conclusions

This example demonstrates a technique for fabrication of leakproof and robust miniaturized valves. The valves are demonstrated to be scalable, and addressable by multiplexing. This technique can be referred as mVLSI because it allows more than two orders of magnitude density improvement over mLSI. mVLSI is attractive for improving throughput, sensitivity, and dynamic range in various chemical and biological applications. One million addressable chambers would allow a single chip to be configured for hundreds of different experiments, or one single experiment with much higher sensitivity and dynamic range. The mVLSI technology is also attractive to the field of optofluidics because the smaller channel size would allow easier integration with single mode photonics devices. mVLSI is demonstrated by the proposed three-layer chip design and by selection of the PDMS processing conditions. It is observed that both 6 and 8 μm valves can be fabricated and used over several days, reproducibly.

### Example 2

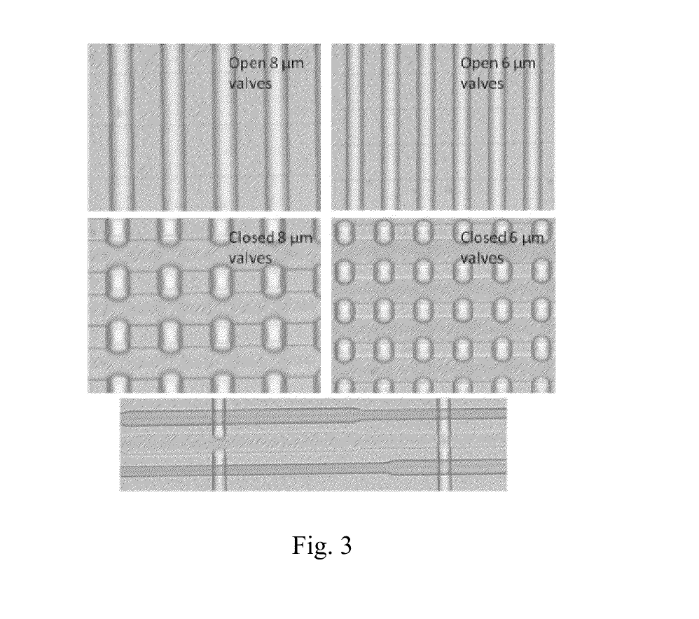

FIG. 6 shows miniaturized valves that are closed after about 2 min and held closed overnight. It can be observed that the valves do not collapse or delaminate after several hours of operation.

### Example 3

This example sets forth optimization of valve characteristics for mVLSI technology.

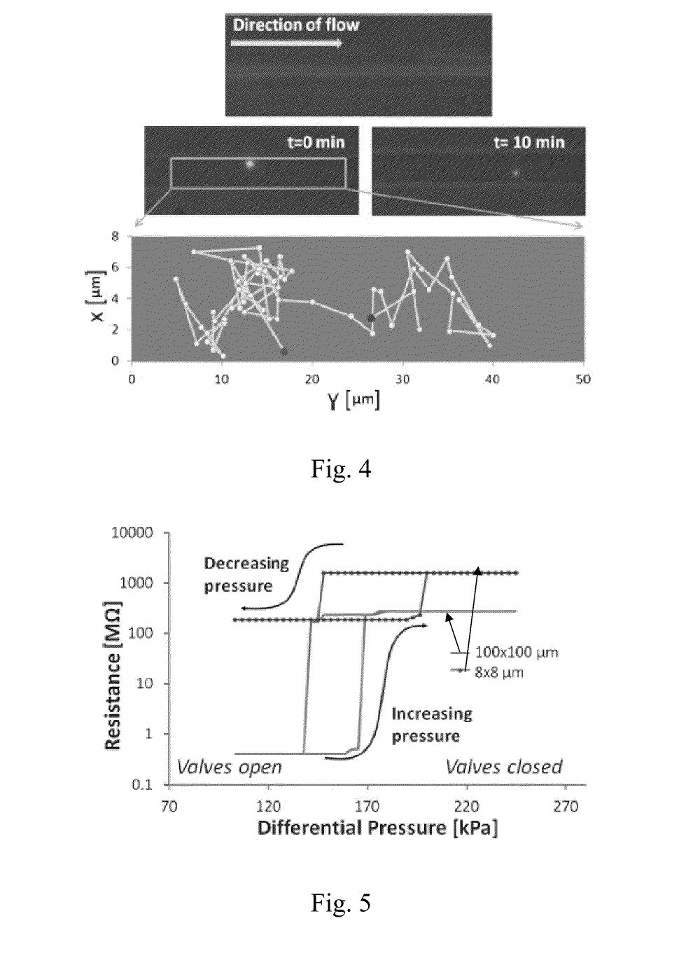

First, chips were made with PDMS mixture with a cross linker ratio of about 1:5 for both control and flow layers and about 1:30 for the membrane layer. The control layer is cured in an oven for about 40 min at about 80° C. Because there is a thickness difference between flow and control layers, the flow layer is cured on a hot plate at about 110° C. for about 1 hr in order to match the shrinkage ratio between them. The partial curing time of the membrane is changed between about 30 min and about 60 min. The actuation pressure is measured for four different valves at each point, and the result is shown in FIG. 7. It can be seen that, as the partial curing time increases, the actuation pressure also increases. For the valves made by about 30 min curing, the response time was relatively slow (>3 sec).

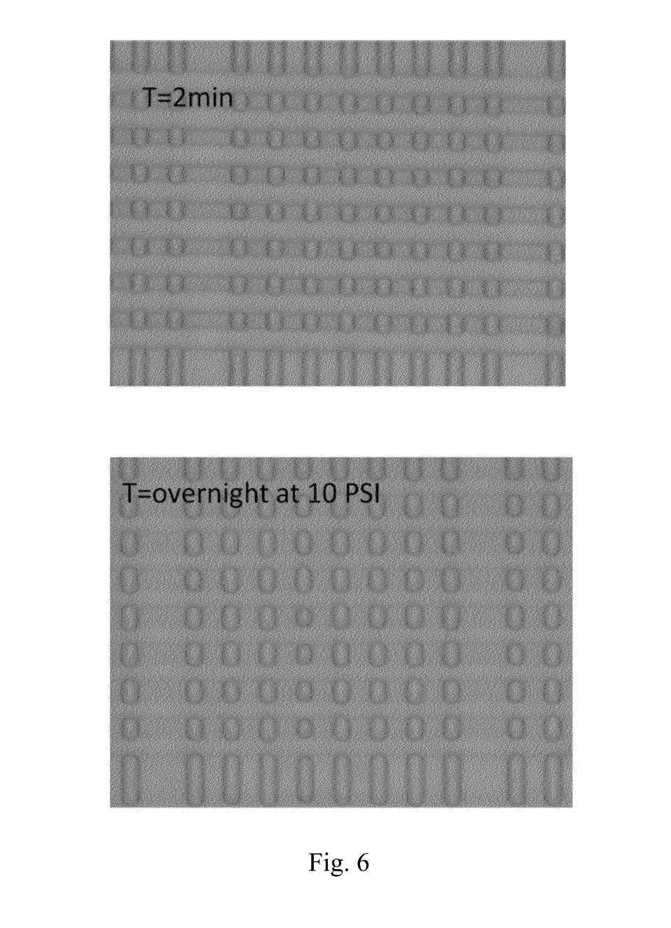

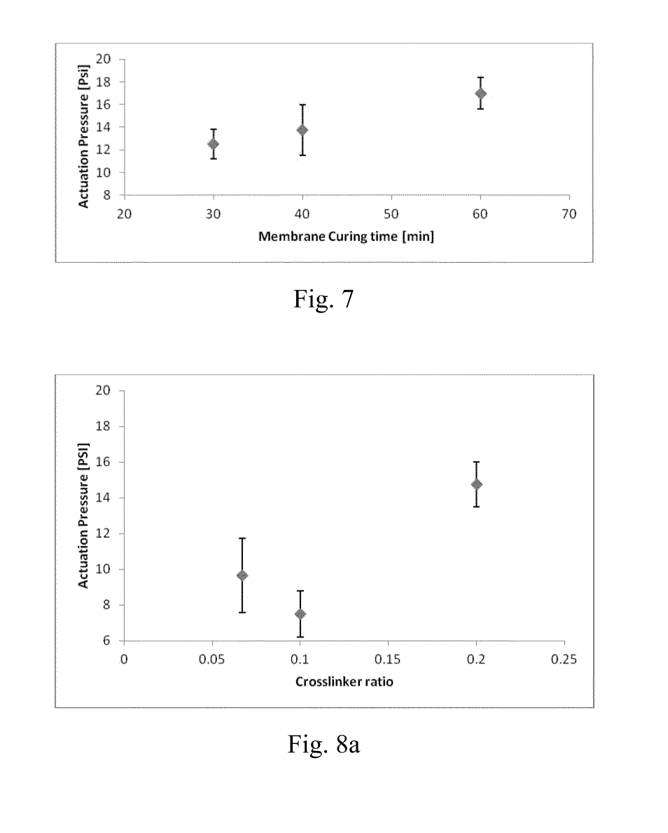

Next, the effect of control layer mixing ratio on the actuation pressure was tested. Chips were made with a control layer mixing ratio of about 1:5, about 1:10, and about 1:15. The results are shown in FIG. 8a. At about 1:10 mixing ratio, the elastic modulus of the control layer is highest, and the stiffness of the control channels leads to lower actuation pressure because the force transfer efficiency to the membrane is higher, resulting in very fast response times (<200 msec). In addition to the improved force transfer efficiency, the cross linker diffusion into the membrane layer was minimum at about 1:10 control layer ratio, which aided in reducing the elastic modulus of the membrane layer and keeping the actuation pressure low. When about 1:10 control layer ratio is used, actuation pressure of 4×4 and 6×6 μm² valves are compared to 8×8 μm² valves as shown in FIG. 8b.

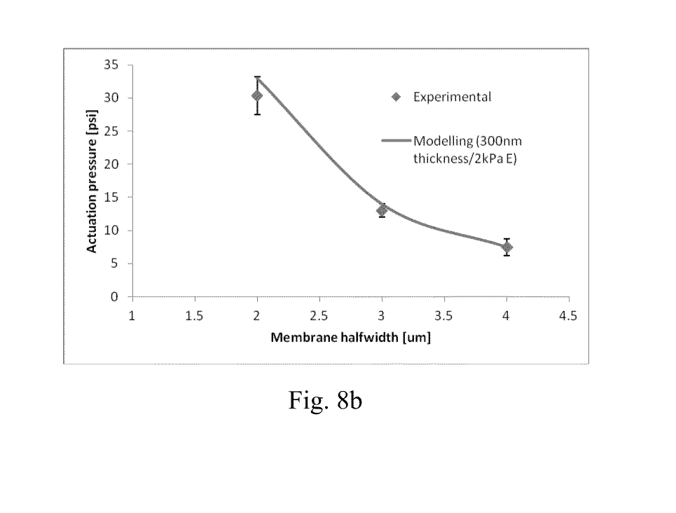

In order to confirm the effect of elastic modulus on the actuation pressure, testing was carried out for three different curing times of the control layer, which was made by 1:5 mixing ratio. It can be seen in FIG. 9 that when the control layer is fully cured (higher elastic modulus) actuation pressure is lower compared to partially cured control layer at about 30 min. This confirms the finding above that, as the elastic modulus of the control layer increases, the actuation pressure is lower.

### Example 4

This example demonstrates the design and fabrication of microfluidic chips with mVLSI technology for multiplexed enzyme-based digital counting, such as digital polymerase chain reaction (digital PCR) or digital enzyme-linked immunosorbent assay (digital ELISA).

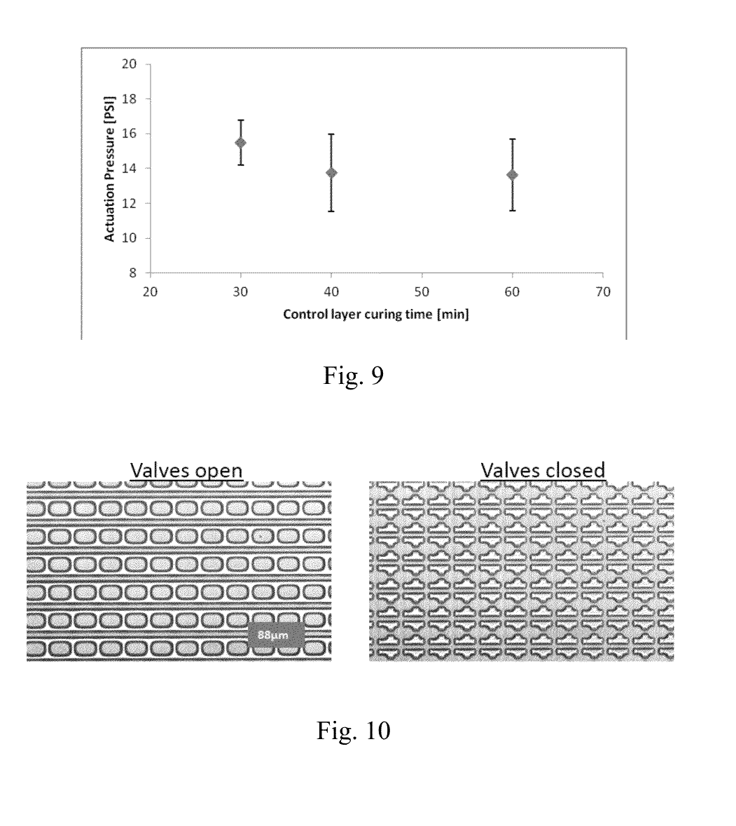

FIG. 10 shows operation of valves, with the valves open (left), and the valves closed (right). Channel size is about 6 μm, with about 500 fL chamber volumes, and 10,000 chambers in 10 mm².

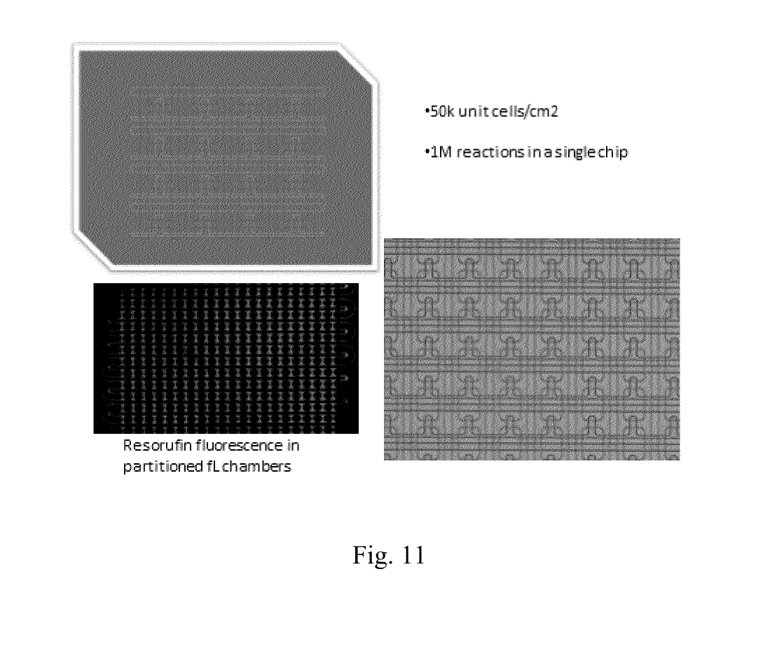

FIG. 11 shows a chip design for single enzyme detection. 50,000 cells are present per cm², and allows about 1 million reactions in a single chip.

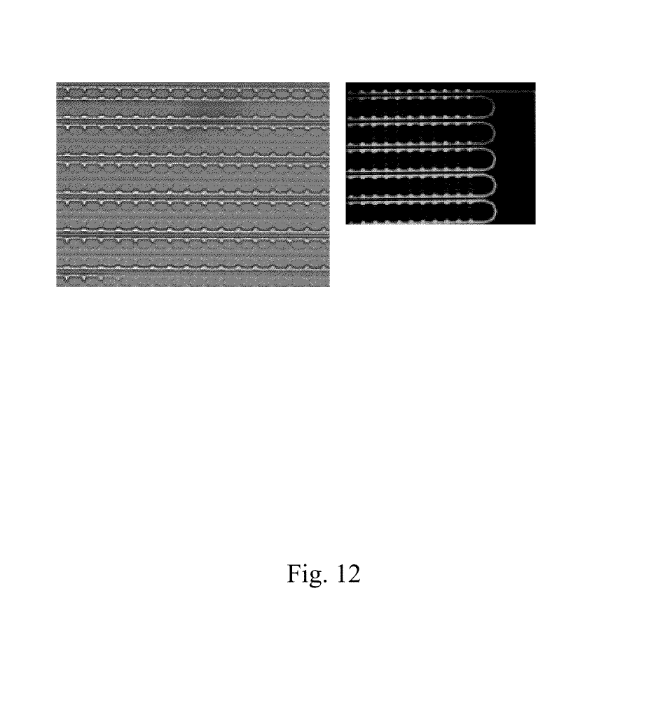

FIG. 12 shows filling of enzyme and substrate into two different channels, and their subsequent mixing in each chamber.

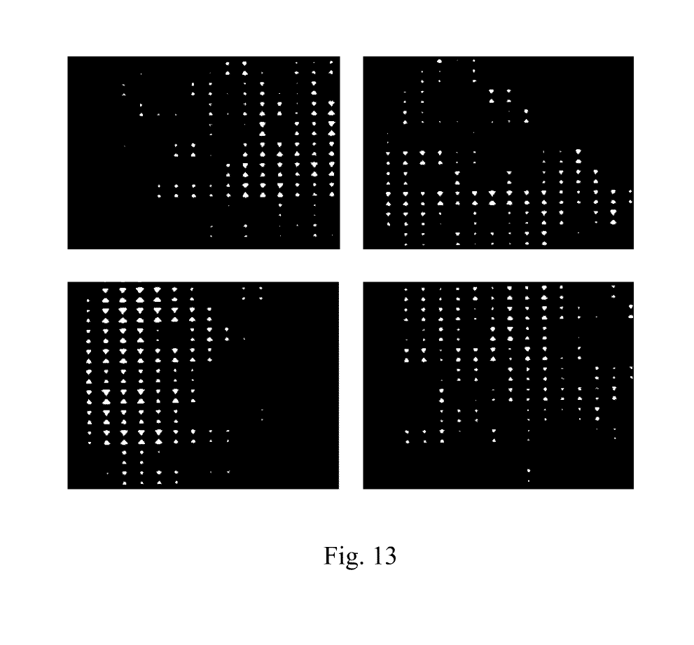

FIG. 13 demonstrates digital counting in an mVLSI chip. Enzyme concentration was about 500 fM (about 1.2 enzyme per chamber). Experiments were repeated at the same location, which demonstrate reusability of the chip.

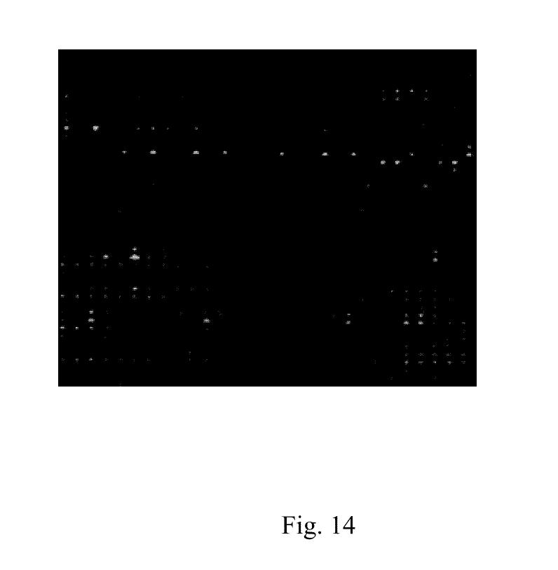

FIG. 14 also demonstrates digital behavior. Enzyme concentration was about 80 fM (about 0.025 enzyme per chamber). Expected occupancy is about 3.2%, and experimental occupancy is about 4%.

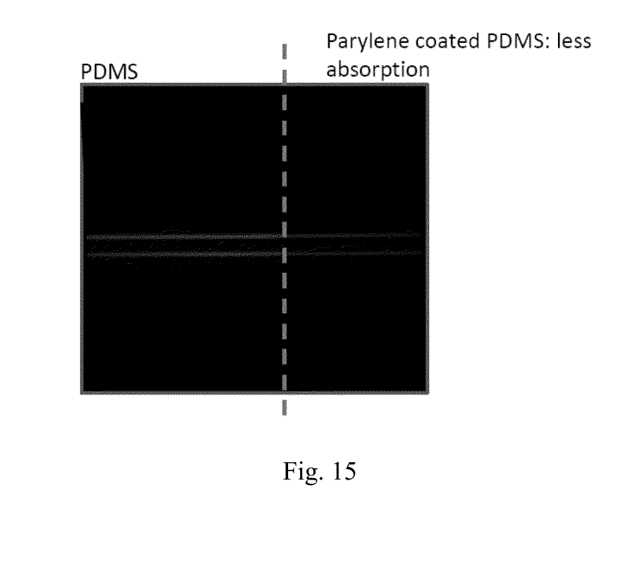

FIG. 15 demonstrates the function of a Parylene coating. The left side of FIG. 15 shows a PDMS surface without a Parylene coating, and the right side of FIG. 15 shows a PDMS surface with a Parylene coating. It can be seen that the Parylene-coated PDMS exhibited less absorption of resorufin after about 2 hours.

As used herein, the singular terms “a,” “an,” and “the” include plural referents unless the context clearly dictates otherwise. Thus, for example, reference to an object can include multiple objects unless the context clearly dictates otherwise.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “oligomer” refers to a molecule having a degree of polymerization up to 10 or composed of up to 10 monomer units, while the term “polymer” refers to a molecule having a degree of polymerization greater than 10 or composed of greater than 10 monomer units.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While this disclosure has been described with reference to the specific embodiments thereof, it should be understood by those skilled in the art that various changes may be made and equivalents may be substituted without departing from the true spirit and scope of this disclosure as defined by the appended claims. In addition, many modifications may be made to adapt a particular situation, material, composition of matter, method, operation or operations, to the objective, spirit and scope of this disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of this disclosure. Accordingly, unless specifically indicated herein, the order and grouping of the operations is not a limitation of this disclosure.

What is claimed is:

1. A fabrication method of a micromechanical valve, comprising:
forming a control layer according to a first weight ratio of cross linker:elastomer base;
forming a flow layer according to a second weight ratio of cross linker:elastomer base;
forming a membrane layer according to a third weight ratio of cross linker:elastomer base, wherein the third weight ratio is smaller than the first weight ratio, and is smaller than the second weight ratio;
bonding the membrane layer to the control layer to form a two-layer structure; and
bonding the two-layer structure to the flow layer to form the micromechanical valve.

2. The fabrication method of claim 1, wherein each of the first weight ratio and the second weight ratio is at least 1:15, and the third weight ratio is no greater than 1:20.

3. The fabrication method of claim 1, wherein each of the first weight ratio and the second weight ratio is at least 1:10, and the third weight ratio is no greater than 1:25.

4. The fabrication method of claim 1, wherein the first weight ratio is in the range of 1:15 to 1: 4.

5. The fabrication method of claim 1, wherein forming the control layer includes at least partially curing the control layer, and forming the flow layer includes at least partially curing the flow layer.

6. The fabrication method of claim 5, wherein at least one of partially curing the control layer and partially curing the flow layer is carried out in a curing oven, and includes flowing dry air into the curing oven.

7. The fabrication method of claim 1, wherein forming the membrane layer is carried out to a thickness up to 1 μm.

8. The fabrication method of claim 1, wherein forming the membrane layer is carried out to a thickness up to 0.5 μm.

9. The fabrication method of claim 1, wherein forming the membrane layer includes at least partially curing the membrane layer.

10. The fabrication method of claim 9, wherein partially curing the membrane layer is carried out in a curing oven, and includes flowing dry air into the curing oven.

11. The fabrication method of claim 1, wherein bonding the membrane layer to the control layer is carried out by thermal bonding.

12. The fabrication method of claim 1, wherein forming the flow layer includes:
forming a flow channel in the flow layer; and
coating the flow channel with a polyxylylene-based polymer.

13. The fabrication method of claim 12, wherein coating the flow channel includes selectively coating a valve region of the flow channel with the polyxylylene-based polymer.

14. The fabrication method of claim 1, wherein an elastic modulus of the membrane layer is up to 500 kPa.

15. The fabrication method of claim 1, wherein a largest lateral dimension of the micromechanical valve is up to 20 μm.

16. A fabrication method of a micromechanical valve, comprising:
forming a first layer having a first elastic modulus;
forming a second layer having a second elastic modulus;
forming a membrane layer having a third elastic modulus, wherein the third elastic modulus is smaller than the first elastic modulus, and is smaller than the second elastic modulus;
bonding the membrane layer to the first layer to form a multi-layer structure; and
bonding the multi-layer structure to the second layer to form the micromechanical valve.

17. The fabrication method of claim 16, wherein the third elastic modulus is up to 500 kPa, and each of the first elastic modulus and the second elastic modulus is at least 1.3 times greater than the third elastic modulus.

18. The fabrication method of claim 16, wherein the third elastic modulus is up to 400 kPa, and each of the first elastic modulus and the second elastic modulus is at least 1.5 times greater than the third elastic modulus.

19. The fabrication method of claim 16, wherein the first layer is a control layer, the second layer is a flow layer, and forming the flow layer includes:
forming a flow channel in the flow layer; and
coating the flow channel with a barrier layer.

20. The fabrication method of claim 19, wherein coating the flow channel includes selectively coating a valve region of the flow channel with the barrier layer.
